(19) United States
(12) Patent Application Publication
(10) Pub. No.: US 2019/0318521 A1
(43) Pub. Date: Oct. 17, 2019

(54) PAGE GENERATION SYSTEM, PAGE GENERATION METHOD AND INFORMATION STORAGE MEDIUM

(71) Applicant: Rakuten, Inc., Tokyo (JP)

(72) Inventor: Takayuki KUROSAWA, Tokyo (JP)

(73) Assignee: Rakuten, Inc., Tokyo (JP)

(21) Appl. No.: 16/385,084

(22) Filed: Apr. 16, 2019

(30) Foreign Application Priority Data
Apr. 17, 2018 (JP) 2018-079087

(51) Int. Cl. G06T 11/60; G06F 3/0483

(52) U.S. Cl. CPC G06T 11/60; G06T 2200/24; G06F 3/0483

(57) ABSTRACT

Provided is a page generation system including at least one processor. The at least one processor is configured to receive, from a poster terminal, each of a plurality of pieces of content to which classification information on a classification is assigned. The at least one processor is configured to determine a plurality of classifications to be displayed on a page of a poster based on the classification information assigned to each of the plurality of pieces of content. The at least one processor is configured to generate the page on which each of the determined plurality of classifications is allowed to be selected, and on which, when anyone of the determined plurality of classifications is selected, content of the selected one of the determined plurality of classifications is displayed.

### TECHNICAL FIELD

The present invention relates to a page generation system, a page generation method, and an information storage medium.

### BACKGROUND ART

Hitherto, there has been known a technology of supporting creation of a page. In Patent Literature 1, there is described a webpage creation method involving causing a poster to select any one of a plurality of pages (e.g., individual pages such as one's house, sports, music, and art) included in a website when adding content to the website, and add the content to the selected page. When a viewer has selected a link displayed on a top page, the content added by the poster is displayed in such a manner as to be classified into each page described above.

### CITATION LIST

### Patent Literature

Patent Literature 1: JP2001-084212A

### SUMMARY OF THE INVENTION

### Technical Problem

However, in the related art, even when a tool (e.g., website builder) for supporting creation of a page is used, it takes time and effort for the poster to add content frequently. For example, even when the webpage creation method of Japanese Patent Application Laid-open No. 2001-084212 is used, the poster is required to select a page to which content is to be added from among a plurality of pages, and select an image to be added to the page as content. In other cases, for example, when there is no page having a classification that fits new content, the poster is required to create a page having a new classification by himself or herself.

The present invention has been made to solve the above-mentioned problems, and has an object to provide a page generation system, a page generation method, and an information storage medium, which enable new content to be easily added to a page on which pieces of content are displayed in a classified manner.

### Solution to Problem

In order to solve the above-mentioned problems, a page generation system according to at least one embodiment of the present invention includes at least one processor, wherein the at least one processor is configured to receive, from a poster terminal, each of a plurality of pieces of content to which classification information on a classification is assigned, wherein the at least one processor is configured to determine a plurality of classifications to be displayed on a page of a poster based on the classification information assigned to each of the plurality of pieces of content, and wherein the at least one processor is configured to generate the page on which each of the determined plurality of classifications is allowed to be selected, and on which, when any one of the determined plurality of classifications is selected, content of the selected one of the determined plurality of classifications is displayed.

A page generation method according to at least one embodiment of the present invention includes : receiving, from a poster terminal, each of a plurality of pieces of content to which classification information on a classification is assigned; determining a plurality of classifications to be displayed on a page of a poster based on the classification information assigned to each of the plurality of pieces of content; and generating the page on which each of the determined plurality of classifications is allowed to be selected, and on which, when any one of the determined plurality of classifications is selected, content of the selected one of the determined plurality of classifications is displayed.

An information storage medium according to at least one embodiment of the present invention is a non-transitory information storage medium having stored thereon a program for causing a computer to: receive, from a poster terminal, each of a plurality of pieces of content to which classification information on a classification is assigned; determine a plurality of classifications to be displayed on a page of a poster based on the classification information assigned to each of the plurality of pieces of content; and generate the page on which each of the determined plurality of classifications is allowed to be selected, and on which, when any one of the determined plurality of classifications is selected, content of the selected one of the determined plurality of classifications is displayed.

In one aspect of the present invention, the poster terminal is configured to enable specification of an order of each of the plurality of pieces of content, the page generation system further includes a storage configured to store, for each of the plurality of classifications, order information on the order of each of the plurality of pieces of content of the each of the plurality of classifications, the at least one processor is configured to: update, when one of the plurality of pieces of content is received, order information on a classification of the one of the plurality of pieces of content stored in the storage based on an order specified for the one of the plurality of pieces of content; and generate, when one of the plurality of classifications is selected, the page on which pieces of content of the one of the plurality of classifications are arranged based on order information on the one of the plurality of classifications stored in the storage.

In one aspect of the present invention, each of the plurality of pieces of content includes an image, the page displays a selective image for selecting a classification for each of the determined plurality of classifications, and the at least one processor is configured to generate the page on which the selective image for each of the determined plurality of classifications includes an image of first content within the each of the determined plurality of classifications.

In one aspect of the present invention, a plurality of items of each of the plurality of pieces of content are grouped, and the poster terminal is configured to enable specification of an order for each piece of grouped content.

In one aspect of the present invention, the at least one processor is configured to: determine, based on a number of pieces of content of each of the plurality of classifications to be displayed on the page, an order of the each of the plurality of classifications; and generate the page on which the plurality of classifications are arranged in a selectable manner in the determined order.

In one aspect of the present invention, the poster terminal is configured to enable specification of an effective period of each of the plurality of pieces of content, and the at least one processor is configured to: set the specified effective period in content for which the effective period is specified; avoid determining a classification of content for which the effective period has elapsed as a classification to be displayed on the page; and determine a classification of content for which the effective period has yet to elapse as a classification to be displayed on the page.

In one aspect of the present invention, the poster terminal is configured to enable specification of a title of each of the plurality of pieces of content, and the at least one processor is configured to, when receiving first content for which the title is specified and second content for which the title is not specified, group the first content and the second content.

In one aspect of the present invention, the poster terminal is configured to enable specification of an image and a character string to be included in each of the plurality of pieces of content, the first content includes content for which a first image is specified and the character string is omitted, the second content includes content for which a second image and the character string are specified, and the at least one processor is configured to, when a classification of the grouped first content and second content is selected, generate the page on which the title of the first content, the first image, the second image, and the character string are displayed in the stated order, for the grouped first content and second content.

In one aspect of the present invention, the at least one processor is configured to: enable selection of a tab of each of the determined plurality of classifications; and generate, when any one of the tabs is selected, the page on which content of a classification indicated by the one of the tabs is displayed.

According to at least one embodiment of the present invention, it is possible to generate a page enabling new content to be easily added to a page on which pieces of content are displayed in a classified manner.

### BRIEF DESCRIPTION OF THE DRAWINGS

FIG. 1 is a diagram for illustrating an entire configuration of a page generation system.

FIG. 2 is a diagram for illustrating an example of a menu screen to be displayed on a poster terminal.

FIG. 3 is a diagram for illustrating an example of a post screen to be displayed on the poster terminal.

FIG. 4 is a diagram for illustrating a situation in which content is selected on the post screen.

FIG. 5 is a diagram for illustrating an example of an information input screen to be displayed on the poster terminal.

FIG. 6 is a diagram for illustrating a situation in which a title, a description, and a classification are input on the information input screen.

FIG. 7 is a diagram for illustrating an example of an advanced settings screen to be displayed on the poster terminal.

FIG. 8 is a diagram for illustrating a situation in which advanced settings of content are performed on the advanced settings screen.

FIG. 9 is a diagram for illustrating an example of a page of a poster to be displayed on a viewer terminal.

FIG. 10 is a diagram for illustrating an example of display of a page in a case where a classification tab is selected.

FIG. 11 is a functional block diagram for illustrating an example of functions to be implemented by a page generation system according to at least one embodiment of the present invention.

FIG. 12 is a table for showing an example of storage of data into a poster database.

FIG. 13 is a table for showing an example of storage of data into a content database.

FIG. 14 is a flowchart for illustrating content posting processing.

FIG. 15 is a flowchart for illustrating the content posting processing.

FIG. 16 is a flowchart for illustrating page generation processing.

FIG. 17 is a flowchart for illustrating the page generation processing.

FIG. 18 is a functional block diagram in modification examples of the present invention.

FIG. 19 is a diagram for illustrating an example of an advanced settings screen in Modification Example (1) of the present invention.

FIG. 20 is a diagram for illustrating transition of a page before and after elapse of an effective period.

FIG. 21 is an explanatory diagram for illustrating processing in Modification Example (2) of the present invention.

### DETAILED DESCRIPTION OF THE INVENTION

### 1. ENTIRE CONFIGURATION OF PAGE GENERATION SYSTEM

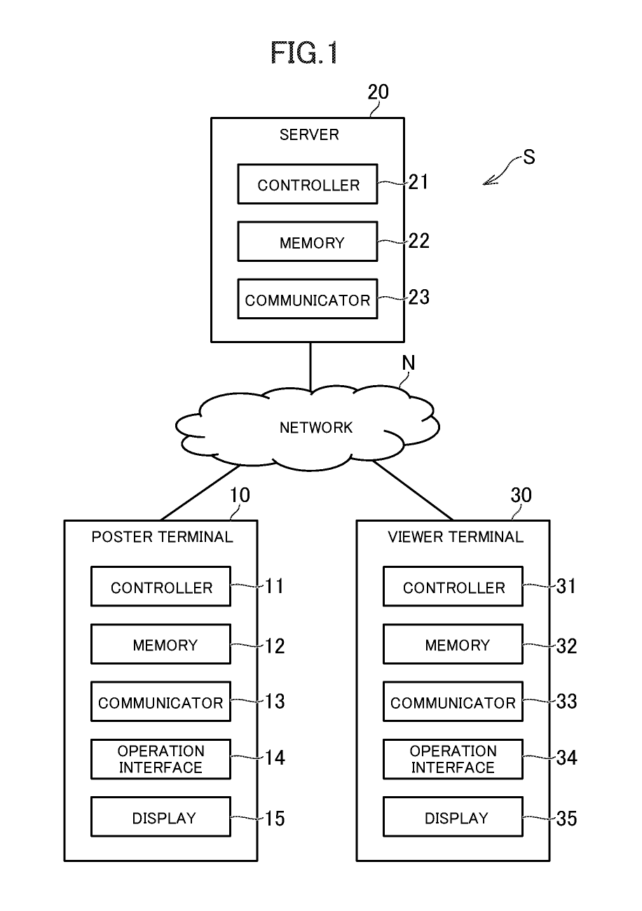

Now, a description is given of a page generation system according to at least one exemplary embodiment of the present invention. FIG. 1 is a diagram for illustrating an entire configuration of the page generation system. As illustrated in FIG. 1, a page generation system S includes a poster terminal 10, a server 20, and a viewer terminal 30. Those components can connect to a network N, for example, the Internet. In FIG. 1, one poster terminal 10, one server 20, and one viewer terminal 30 are illustrated. However, there may be a plurality of poster terminals 10, a plurality of servers 20, and a plurality of viewer terminals 30.

The poster terminal 10 is a computer to be operated by a poster. The “poster” is a user who posts content. In other words, the poster is a user who provides or creates content, and may also be referred to as “provider” or “creator”. The poster may be an individual, or an organization such as a corporation, a municipality, a facility, or a school. When the poster is an organization, an account of the organization may be created so that the organization itself serves as a poster. Alternatively, an account of a worker of the organization may be created so that the worker of the organization serves as a poster. Herein, “posting” refers to transmitting (uploading) content to the server 20.

“Content” is information (data) to be provided to a viewer described later, and may be, for example, an image, a moving image, text, sound, music, or a combination thereof, or may be a file or an application. In at least one embodiment, a description is given on the assumption that the “image” means a still image. However, the “image” may have a meaning including a moving image. For example, an image or moving image photographed by a camera may correspond to content, or an image (computer graphics) or moving image (animation) created by graphic software may correspond to content.

For example, the poster terminal 10 is a cell phone (including a smartphone), a portable information terminal (including a tablet computer), and a personal computer. In at least one embodiment, the poster terminal 10 includes a controller 11, a memory 12, a communicator 13, an operation interface 14, and a display 15.

The controller 11 includes at least one microprocessor. The controller 11 executes processing in accordance with programs and data stored in the memory 12. The memory 12 includes a main memory and an auxiliary memory. For example, the main memory is a volatile memory, for example, a RAM, and the auxiliary memory is a non-volatile memory such as a ROM, an EEPROM, a flash memory, or a hard disk drive. The auxiliary memory included in the memory 12 is also referred to as “storage”.

The communicator 13 is a communication interface for wired communication or wireless communication, and performs data communication via the network. The operation interface 14 is an input device to be used by the user for operation, and is, for example, a pointing device such as a touch panel and a mouse, a keyboard, or a button. The operation interface 14 transmits details of operation by the user to the controller 11. The display 15 is, for example, a liquid crystal display or an organic EL display. The display 15 displays an image in accordance with an instruction of the controller 11.

The server 20 is a server computer. The server 20 includes a controller 21, a memory 22, and a communicator 23. The physical configurations of the controller 21, the memory 22, and the communicator 23 may be similar to those of the controller 11, the memory 12, and the communicator 13, respectively.

The viewer terminal 30 is a computer to be operated by a viewer. The “viewer” is a user who views content. In other words, the viewer is a user who is provided with content, and may also be referred to as “end user”. Herein, “viewing” refers to viewing content through a screen, and displaying or downloading content.

For example, the viewer terminal 30 is a cell phone (including a smartphone), a portable information terminal (including a tablet computer), or a personal computer. In at least one embodiment, the viewer terminal 30 includes a controller 31, a memory 32, a communicator 33, an operation interface 34, and a display 35. The physical configurations of the controller 31, the memory 32, the communicator 33, the operation interface 34, and the display 35 may be similar to those of the controller 11, the memory 12, and the communicator 13, the operation interface 14, and the display 15, respectively.

Programs and data to be described as being stored into the memories 12, 22, and 32 may be supplied thereto via the network N. Further, the respective hardware configurations of the computers are not limited to the above-mentioned examples, and various types of hardware can be applied thereto. For example, the hardware configuration may include a reader (for example, an optical disc drive or a memory card slot) configured to read a computer-readable information storage medium, or an input/output interface (for example, a USB port) configured to input and output data to/from an external device. For example, the program and the data stored in the information storage medium may be supplied to each of the computers through intermediation of the reader or the input/output interface.

### 2. OUTLINE OF PAGE GENERATION SYSTEM

The page generation system S is configured to generate a page of a poster based on content posted by the poster. The “page” refers to information to be displayed on the screen, and is also sometimes referred to as “document”. A page includes at least one piece of content. For example, a page is prepared for each poster, and is viewed through use of, for example, a browser or an application of the viewer terminal 30. The page may be a webpage, a website, or a homepage.

In at least one embodiment, a description is given of a facility such as a hotel or a restaurant as an example of the poster. For example, the poster posts, for example, a picture or description of the facility as content, and the page generation system S generates a page for introducing the facility. The page can be customized (edited) by the poster. When the poster uses a browser to access the server 20 or activate a predetermined application, a menu screen for customizing its page is displayed on the display 15.

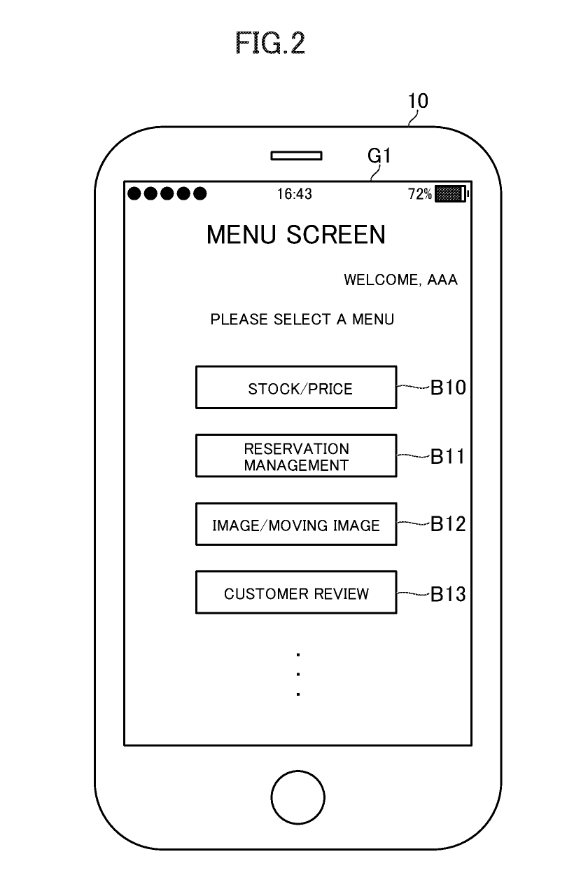

FIG. 2 is a diagram for illustrating an example of a menu screen to be displayed on the poster terminal 10. As illustrated in FIG. 2, various kinds of buttons for using a service provided by the page generation system S are displayed on a menu screen G1. Now, a description is given taking an exemplary case in which a poster who has logged in with the facility name of “AAA hotel” uses the service.

The page generation system S may provide a service other than the service of generating a page, and may display, on the menu screen G1, a button B10 for checking a reservation status of the facility or setting a price, for example. In addition, the menu screen G1 may display a button B11 for managing reservation of the facility, a button B12 for posting content, and a button B13 for checking a review of a customer.

Now, a description is given of processing in a case where the poster posts content. For example, when the poster has selected the button B12 on the menu screen G1, a post screen for posting content is displayed on the display 15. Now, a description is given taking an exemplary case in which an image or moving image is posted as content.

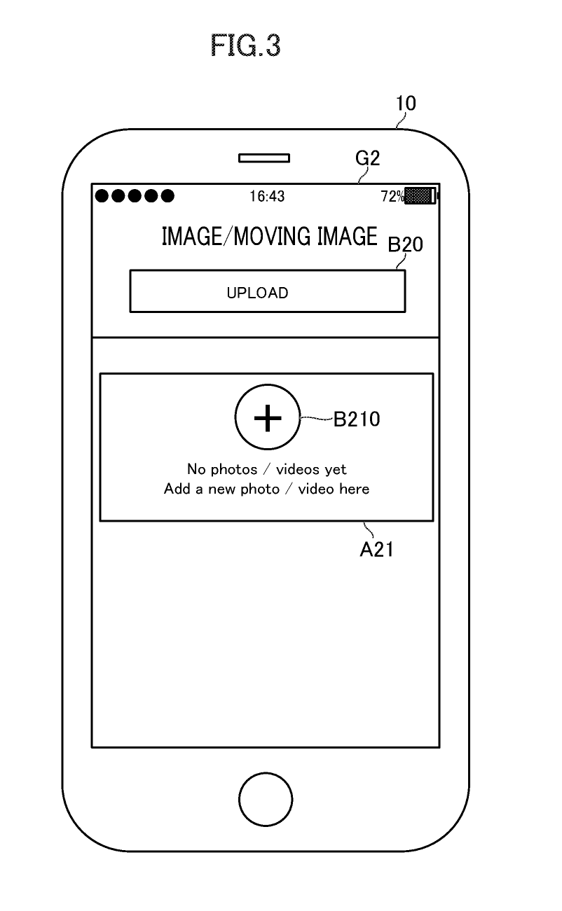

FIG. 3 is a diagram for illustrating an example of the post screen to be displayed on the poster terminal 10. As illustrated in FIG. 3, a button B20 for posting content and a display region A21 for displaying selected content are displayed on a post screen G2. In the example of FIG. 3, content is not selected yet, and thus a message urging selection of content is displayed on the display region A21.

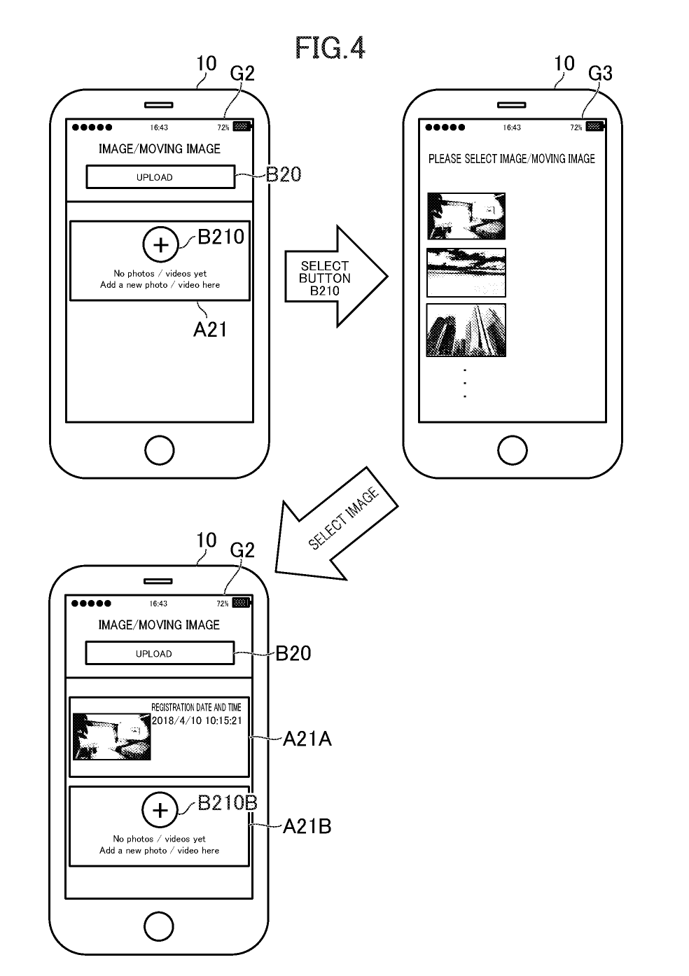

FIG. 4 is a diagram for illustrating a situation in which content is selected on the post screen G2. As illustrated in FIG. 4, when the poster has selected a button B210 displayed on the display region A21, a selection screen G3 for showing a list of postable images or moving images is displayed on the display 15. For example, an image or moving image stored in the memory 32 of the viewer terminal 30 may be displayed on the selection screen G3. Further, an image or moving image stored in other computers, for example, a cloud server (not shown) may be displayed on the selection screen G3. In other cases, for example, an image or moving image stored in the information storage medium such as a USB memory or an SD card may be displayed on the selection screen G3.

The poster selects an image or moving image to be posted as content from among images or moving images displayed on the selection screen G3. Now, a description is given of a case in which any one of images or moving images displayed on the selection screen G3 is selected. However, a set of a plurality of images or moving images may be selected.

As illustrated in FIG. 4, when an image or moving image is selected on the selection screen G3, the post screen G2 is displayed again, and the selected image or moving image is displayed on a display region A21A. In the example of FIG. 4, a picture of a room in the facility is selected, and the picture is displayed on the display region A21A. A date and time at which the image or moving image has been selected may be displayed on the display region A21A.

The image or moving image, which has been selected on the selection screen G3, may automatically be posted to the server 20. In at least one embodiment, it is assumed that the image or moving image is posted to the server 20 when the button B20 is selected. In FIG. 4, the button B20 is not selected yet, and thus the picture displayed on the display region A21A is not posted to the server 20 yet.

For example, when an image or moving image is displayed on the display region A21A, as illustrated in FIG. 4, a display region A21B for selecting a second image or moving image is displayed. When the poster has selected a button B210B displayed on the display region A21B, the selection screen G3 is displayed, and the second image or moving image can be selected similarly to the procedure described above. The third and subsequent images or moving images can be selected in accordance with a similar procedure.

The poster is not required to select a plurality of images or moving images, and may select and post only one image or moving image. Further, the image or moving image may be posted one by one. Alternatively, a set of a plurality of images or moving images may be posted at once. When a set of a plurality of images or moving images is posted at once, individual images or moving images may be treated as separate pieces of content. In other cases, those plurality of images or moving images may be treated as one piece of content.

The poster may post only the image or moving image as content. However, in at least one embodiment, a title, a description, or a classification may be assigned to the image or moving image.

The “title” is a title of content, and is, for example, a character string indicating an outline of the content. In at least one embodiment, an image or moving image is selected as content, and thus the title indicates the name of the image or moving image. For example, a character string of several to several tens of characters is input as the title. The title may be omitted.

The “description” is a description of content, and is, for example, a sentence indicating details of the content. In at least one embodiment, an image or moving image is selected as content, and thus the description is a sentence indicating the details of the image or moving image. For example, a character string of several tens to thousands of characters is input as the description. The description may be treated as one type of content, and the content may include an image or moving image and a description. The description may be omitted.

The “classification” is a property of content, and may also be referred to as, for example, “type”, “attribute”, “label”, “category”, or “genre”. In other words, the classification may be information called “tag” or “hash tag” in the field of internet technology. In at least one embodiment, the poster may specify any classification that depends on details of content, and several to several tens of characters are input as the classification. The classification may be omitted.

For example, when the poster has selected the display region A21A displaying a selected image or moving image, an information input screen for assigning a title, a description, and a classification to the image or moving image is displayed on the display 15.

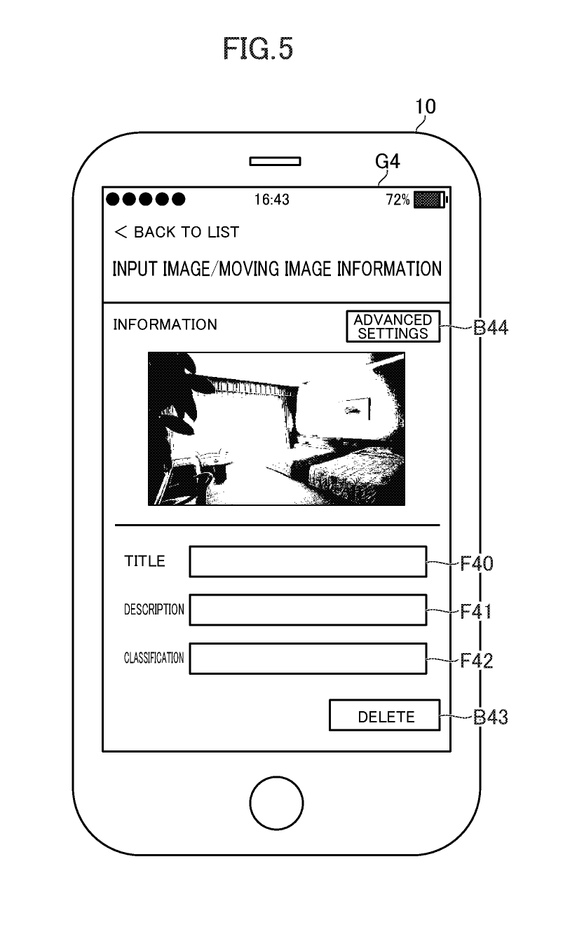

FIG. 5 is a diagram for illustrating an example of the information input screen to be displayed on the poster terminal 10. As illustrated in FIG. 5, an input form F40 for inputting a title, an input form F41 for inputting a description, and an input form F42 for inputting a classification are displayed on an information input screen G4 together with an image or moving image selected by the poster. When the poster has selected a button B43, the image or moving image can be deleted.

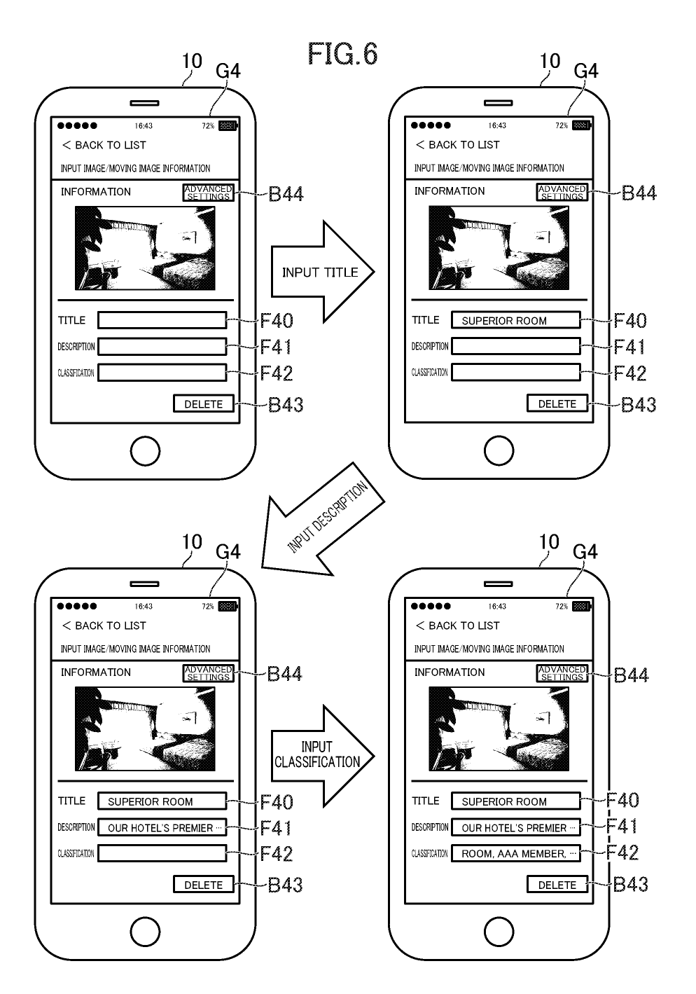

FIG. 6 is a diagram for illustrating a situation in which a title, a description, and a classification are input on the information input screen G4. As illustrated in FIG. 6, the poster selects the input form F40 on the information input screen G4, and inputs any character string indicating the title of the selected image or moving image. In the example of FIG. 6, an image of a room in the facility is selected, and thus the poster inputs a room name, for example, “superior room” as the title.

Further, for example, the poster selects the input form F41 on the information input screen G4, and inputs any character string indicating the description of the selected image or moving image. In the example of FIG. 6, an image of a room in the facility is selected, and thus the poster inputs, as the description, a character string indicating, for example, characteristics or equipment of the room. The classification may be input into the input form F41. In this case, a specific symbol such as “#” or “%” may be set at the head of the classification in order to distinguish between the classification and the description.

Further, for example, the poster selects the input form F42, and inputs any character string indicating the classification of the selected image or moving image. Only one classification may be input, or a plurality of classifications may be input. In the example of FIG. 6, an image of a room in the facility is selected, and this room is assumed to be a room only for a member of the facility. Thus, the poster inputs, as the description, a character string indicating the classification of the image, such as “room” or “AAA member”.

Classifications input by the poster in the past may be displayed on the information input screen G4 in a selectable manner. In this case, the poster may select a classification to be assigned to the image or moving image from among a plurality of classifications input in the past. Further, when the description includes a specific word, the specific word may be assigned as the classification. For example, the specific word may be a word defined in advance by the poster, or may be a word repeatedly used in content of the poster. For example, when the number of times of usage of a word becomes equal to or larger than a threshold value, the word may be used as the classification.

Further, the information to be assigned to content is not limited to the above-mentioned examples, and other information may be assigned. For example, an order of content may be assigned within a classification. The order is an order of display (arrangement order) of content in a page of the poster described later. In at least one embodiment, pieces of content are arranged in a vertical direction, and thus the order is a numerical value indicating the order from the top. When pieces of content are arranged in a horizontal direction, the order is a numerical value indicating the order from the left or the right. For example, when the poster has selected a button B44 on the information input screen G4, an advanced settings screen for setting, for example, the order of content is displayed on the display 15.

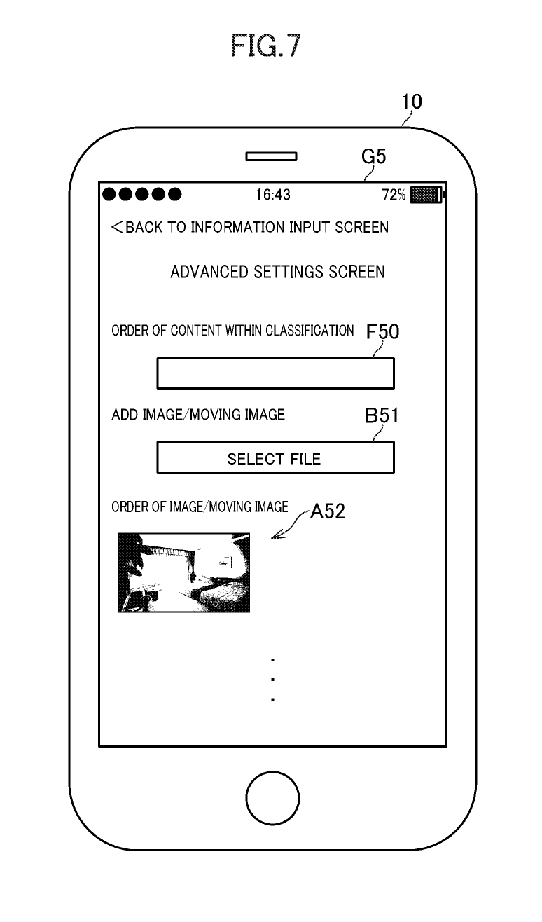

FIG. 7 is a diagram for illustrating an example of the advanced settings screen to be displayed on the poster terminal 10. As illustrated in FIG. 7, an input form F50 for specifying an order within a classification is displayed on an advanced settings screen G5. When a plurality of classifications are specified, different orders may be specified for respective classifications. In the examples of FIG. 7, two classifications, namely, “room” and “AAA member” are specified for the content, and thus the order within the classification of “room” and the order within the classification of “AAA member” may be specified on the input form F50.

Advanced settings of content are not limited to the setting of the order within a classification, but may be other settings. For example, advanced settings of content may be to add an image or moving image. In other cases, when one piece of content includes a plurality of images or moving images, advanced settings of the content may be to specify the order of images or moving images within the content. In other cases, for example, as in a modification example of the present invention described later, advanced settings of the content may be to set an effective period for the content.

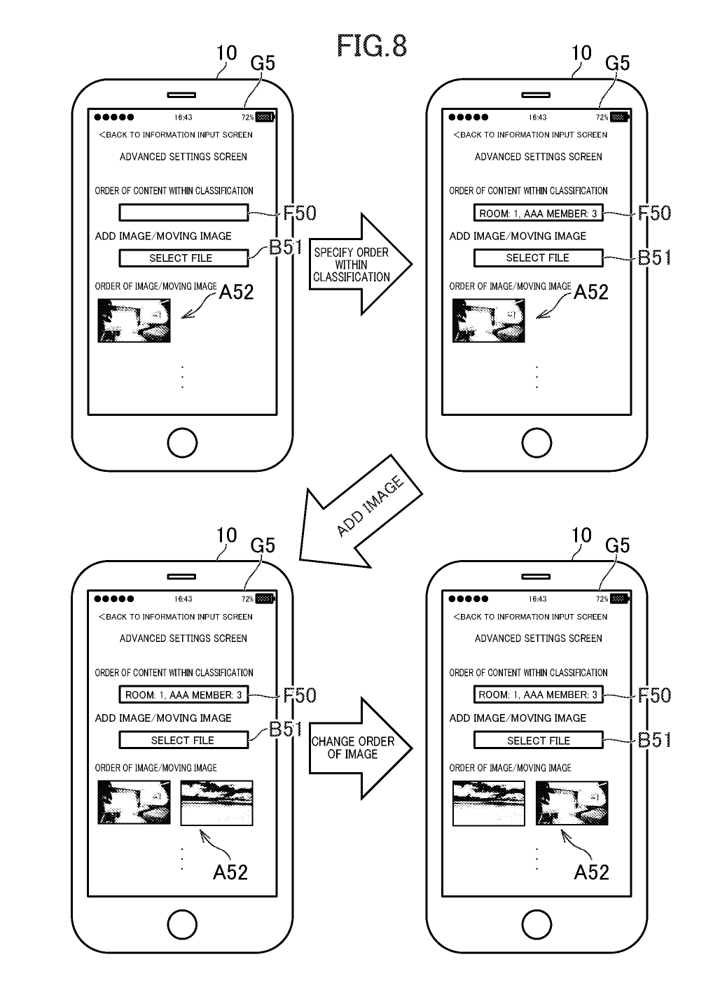

FIG. 8 is a diagram for illustrating a situation in which advanced settings of content are performed on the advanced settings screen G5. As illustrated in FIG. 8, for example, the poster inputs the order of content within a classification into the input form F50. In the example of FIG. 8, the order of content within a classification is input so that the order within the classification of “room” is set as “first” and the order within the classification of “AAA member” is set as “third”.

Further, for example, the poster selects a button B51 to select an image or moving image to be added as content. For example, when the poster has selected the button B51, the selection screen G3 is displayed again, and an image or moving image to be added can be selected similarly to the procedure described above. Also in this case, the image or moving image to be added may be selected one by one. In other cases, a set of a plurality of images or moving images may be posted at once.

Further, for example, when the content includes a plurality of images or moving images, those plurality of images or moving images are displayed on a display region A52. The poster can drag and drop an image or moving image displayed on the display region A52 to switch the order within the content. The meaning of “order” is as described above.

The description has been given of the case in which a numerical value indicating the order within a classification is input into the input form F50. However, the method of specifying the order is not limited thereto. For example, the order may be specified in a pull-down format. In this case, the poster terminal 10 may request the server 20 for the number of pieces of content of the classification specified by the poster, and any number within the number of pieces of content plus one may be selected.

Further, for example, the poster terminal 10 may request the server 20 for posted content, and display the selected content and the posted content on the advanced settings screen G5 in line with each other. Then, the poster may drag and drop the selected content and the posted content, for example, to specify the order within the classification. In other cases, for example, a preview screen of a page of the poster described later may be displayed, and the poster may drag and drop content on the preview screen to specify the order.

As described above, the poster assigns a title, a description, and a classification to the selected image or moving image, and specifies the order within a classification and the order within content. When the poster finishes inputting those pieces of information, the poster selects the button B20 on the post screen G2, and posts content to the server 20. After the content is posted to the server 20, the title, the description, the classification, the order within the classification, and the order within the content may be changed.

When the content is posted to the server 20, the viewer can view the content. For example, when the viewer terminal 30 accesses the server 20, the posted content is displayed on the page of the poster.

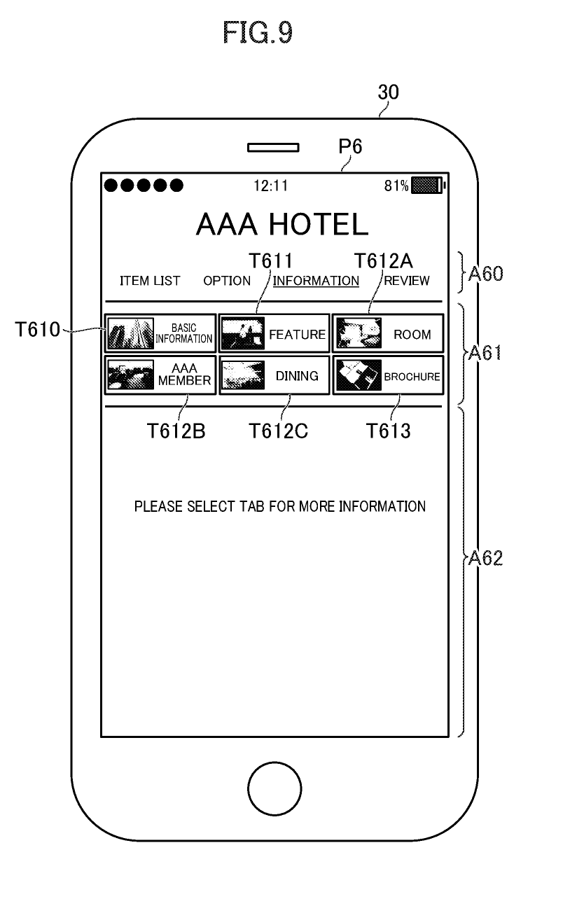

FIG. 9 is a diagram for illustrating an example of a page of the poster to be displayed on the viewer terminal 30. As illustrated in FIG. 9, a page title of “AAA hotel” is displayed on a page P6 of the poster, which enables identification of the poster associated with the page.

Further, a menu of the page P6 is displayed on a display region A60 of the page P6. For example, the menu displays items such as “item list” for displaying a list of rooms of the facility, “options” for displaying options at the time of stay, “information” for displaying posted content, and “review” for displaying a review of a guest.

Now, a description is given of an example of display in a case where the “information” is selected on the display region A60. As illustrated in FIG. 9, when the “information” is selected on the display region A60, a basic information tab T610, a feature tab T611, classification tabs T612A to T612C, and a brochure tab T613 are displayed on a display region A61 of the page P6.

For example, the basic information tab T610 is a tab for displaying basic information on the facility. The basic information on the facility is a kind of content, and is information such as an image or moving image of the facility, a facility name, an address, a phone number, or an email address. The basic information on the facility may be posted via a user interface similar to the post screen G2, or may be posted via a user interface different from the post screen G2.

Further, for example, the feature tab T611 is a tab for displaying recommended content from among pieces of content posted by the poster. The recommended content may be specified by a viewer or defined dynamically depending on, for example, the number of viewers. In other cases, for example, a classification of “feature” may be prepared, and content to which the classification is assigned may be displayed.

Further, for example, the classification tabs T612A to T612C are tabs for displaying content for each classification input by the poster. In the following, the classification tabs T612A to T612C are described simply as the “classification tab T612” when those tabs are not particularly required to be distinguished from one another. Further, in this description, it is assumed that there are three classification tabs T612. However, there may be any number of classification tabs T612, and for example, there may be two classification tabs T612 or four or more classification tabs T612. The number of classification tabs T612 to be displayed on the page P6 may be a fixed value, or may change depending on the number of classifications specified by the poster.

For example, a representative image is displayed on the classification tab T612 together with text indicating the classification name. The representative image may be any image of the classification, but in this description, it is assumed that the representative image is an image of first content in the classification. When the first content includes a plurality of images, the representative image may be any image of the first content. However, in this description, it is assumed that the representative image is a first image in the content.

For example, a representative image of the classification of “room” is displayed on the classification tab T612A together with text indicating the classification of “room” input by the poster. Further, for example, a representative image of the classification of “AAA member” is displayed on the classification tab 1612B together with text indicating the classification of “AAA member” input by the poster. Further, for example, a representative image of the classification of “dining” is displayed on the classification tab T612C together with text indicating the classification of “dining” input by the poster.

When the viewer has selected the classification tab T612, pieces of content of the classification indicated by the classification tab T612 are filtered, and are displayed on a display region A62 in an order specified by the poster.

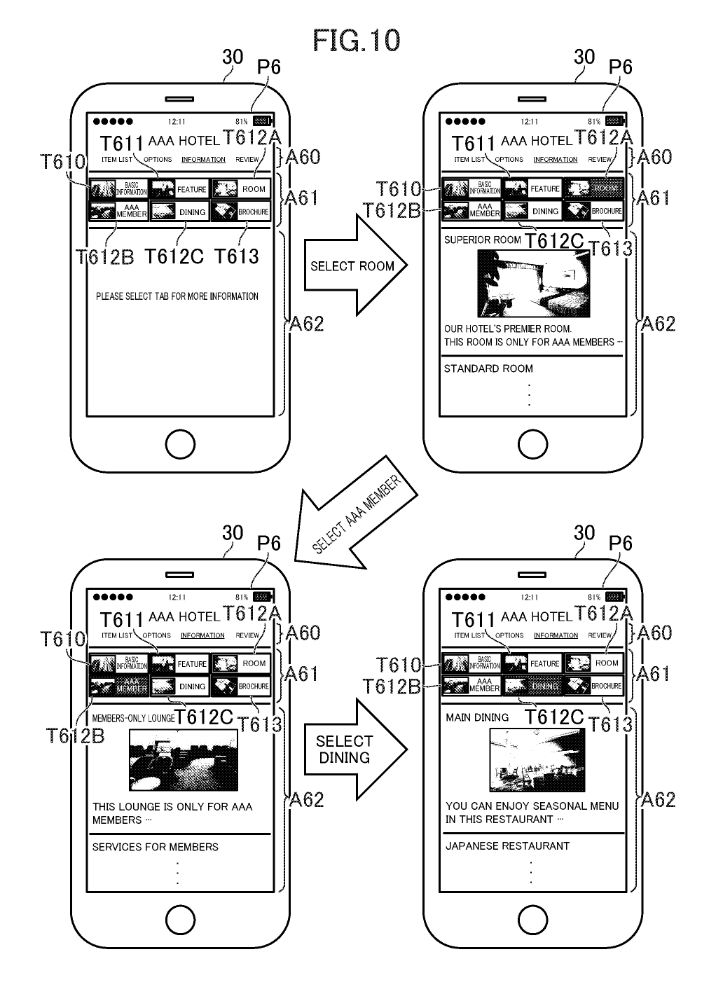

FIG. 10 is a diagram for illustrating an example of display of the page P6 in a case where the classification tab T612 is selected. As illustrated in FIG. 10, when the viewer has selected the classification tab T612A, content of the classification of “room” indicated by the classification tab T612A is displayed on the display region A62 in an order specified by the poster. In the example of FIG. 10, content assigned with the title of “superior room” is displayed first, and content assigned with the title of “standard room” is displayed second.

As described with reference to FIG. 6, the content assigned with the title of “superior room” is assigned with two classifications, namely, “room” and “AAA member”, and thus this content can be displayed through use of the two classification tabs T612A and T612B. That is, content assigned with a plurality of classifications can be displayed through use of the classification tab T612 of each of the plurality of classifications.

Further, for example, when the viewer has selected the classification tab T612B, content classified into “AAA member” indicatedby the classification tab T612B is displayed on the display region A62 in an order specified by the poster. In the example of FIG. 10, content assigned with the title of “members-only lounge” is displayed first, and content assigned with the title of “services for members” is displayed second.

Further, for example, when the viewer has selected the classification tab T612C, content classified into “dining” indicatedby the classification tab T612C is displayed on the display region A62 in an order specified by the poster. In the example of FIG. 10, content assigned with the title of “main dining” is displayed first, and content assigned with the title of “Japanese restaurant” is displayed second.

In FIG. 10, the first and second pieces of content in each classification are displayed on the display region A62. However, it is possible to display third and subsequence pieces of content by scrolling the screen. Further, the description has been given of the case in which each piece of content is displayed in such a manner that the title is displayed first and the image is displayed second, or the moving image is displayed first and the description is displayed second. However, those orders may be specified by the poster. For example, the description may be displayed before the image or moving image.

Further, the brochure tab T613 is a tab for downloading the page P6 in a document file format. When the viewer has selected the brochure tab T613, content displayed on the display region A62 can be downloaded in a document file format.

As described above, in the page generation system S according to at least one embodiment, content is assigned with any classification specified by the poster, and the page P6 on which the classification tab T612 can be selected for each classification is generated. Now, a description is given of details of this technology.

### 3. FUNCTIONS TO BE IMPLEMENTED IN AT LEAST ONE EMBODIMENT

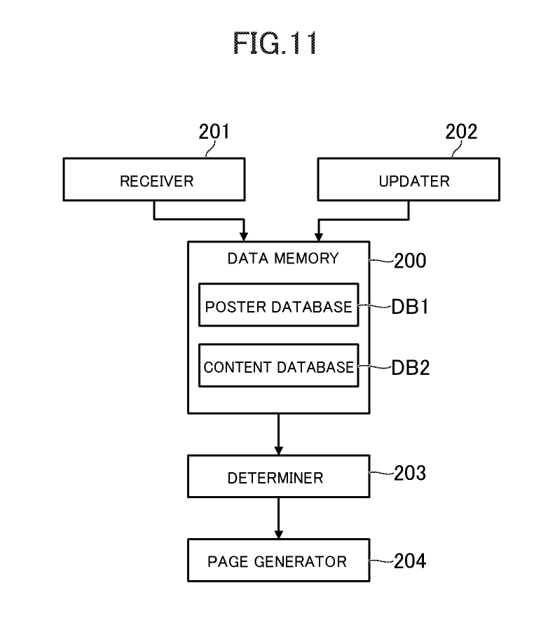

FIG. 11 is a functional block diagram for illustrating an example of functions to be implemented by the page generation system S according to at least one embodiment of the present invention. In at least one embodiment, a description is given of a case in which primary functions are implemented by the server 20. However, as in a modification example of the present invention described later, at least two of the poster terminal 10, the server 20, and the viewer terminal 30 may implement the functions in a distributed manner.

As illustrated in FIG. 11, the page generation system S implements a data memory 200, a receiver 201, an updater 202, a determiner 203, and a page generator 204. The data memory 200, the receiver 201, the updater 202, the determiner 203, and the page generator 204 are examples of storage means, reception means, update means, determination means, and page generation means, respectively.

### [3-1. Data Memory]

The data memory 200 is mainly implemented by the memory 22. The data memory 200 stores data required for generating the page P6. Now, a description is given of a poster database DB1 and a content database DB2 as an example of data to be stored in the data memory 200.

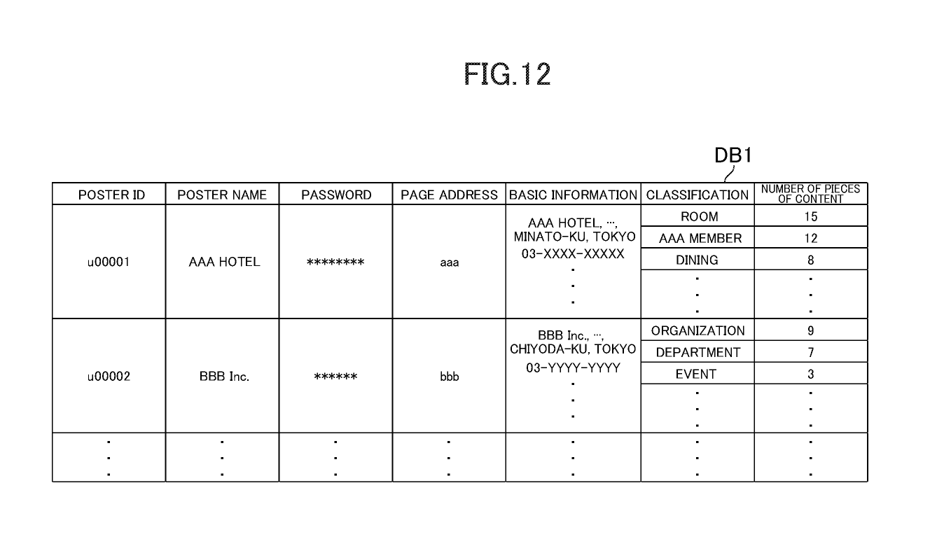

FIG. 12 is a table for showing an example of storage of data into the poster database DB1. As shown in FIG. 12, the poster database DB1 is a database for storing information on a poster. For example, the poster database DB1 stores information such as a poster ID for uniquely identifying a poster, a name (account name) of the poster, a password, address information on a page, basic information, a classification input by the poster, and the number of pieces of content. The classification and the number of pieces of content to be stored into the poster database DB1 are updated appropriatelywhen the poster posts content or specifies a new classification.

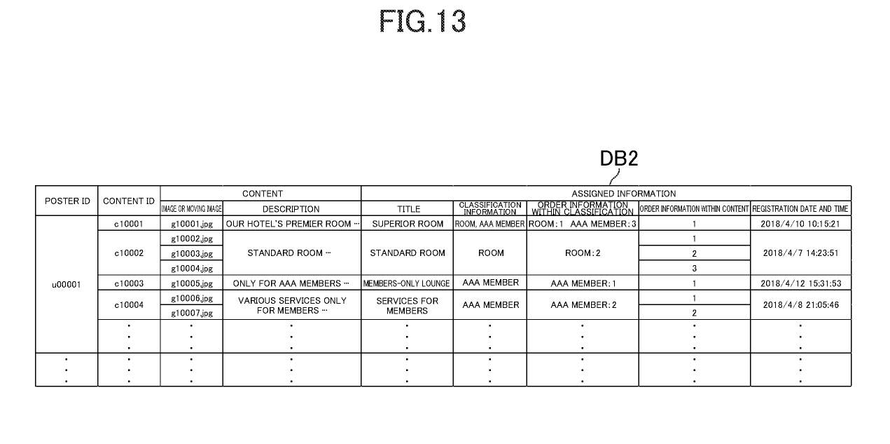

FIG. 13 is a table for showing an example of storage of data into the content database DB2. As shown in FIG. 13, the content database DB2 is a databased for storing content. For example, the content database DB2 stores a poster ID, a content ID for uniquely identifying content, content, and assigned information.

The assigned information is information assigned to content, and is, for example, a title, classification information, order information on the classification, order information within the content, and a registration date and time. The classification information is information on the classification, and may be, for example, a character string indicating the classification or a classification ID for uniquely identifying the classification. In at least one embodiment, a character string input to the input form F42 at the time of posting content is stored as the classification information.

The order information on the classification indicates an order of content within the classification. For example, when n (n is a natural number) pieces of content belong to the classification, any one order of from “first” to “n-th” is specified for each of those pieces of content. When only one piece of content belongs to the classification, the order information on the classification may not be stored.

The order information within the content indicates an order of an image or moving image in the content. For example, when k (k is a natural number) images or moving images belong to the content, any one order of from “first” to “k-th” is specified for each of the images or moving images. When only one image or moving image belongs to the content, the order information within the content may not be stored.

The order of content can be specified in the poster terminal 10 in at least one embodiment. The data memory 200 stores the content database DB2 to store, for each classification, the order information on the order of content within the classification.

The data to be stored into the data memory 200 is not limited to the above-mentioned example. For example, the data memory 200 may store image data for displaying screens illustrated in FIG. 2 to FIG. 10, or may store layout data indicating the layout of the page P6.

### [3-2. Receiver]

The receiver 201 is mainly implemented by the controller 21. The receiver 201 receives, from the poster terminal 10, each of a plurality of pieces of content to which classification information on the classification is assigned. The receiver 201 can repeatedly receive content, and may receive one piece of content through one reception, or may receive a plurality of pieces of content at once through one reception. The receiver 201 stores the received content into the content database DB2 in association with the classification information.

For example, when the poster has selected the button B20 on the post screen G2, the poster terminal 10 transmits, to the server 20, a data set including an image or moving image, a title, a description, classification information, order information on the classification, and order information on the content. When the receiver 201 has received the data set, the receiver 201 creates a new record in the content database DB2, and issues a content ID. The content ID is issued so as not to overlap with that of other content based on a predetermined issuance rule. The receiver 201 stores the content ID and the received data set into the record in association with each other.

### [3-3. Updater]

The updater 202 is mainly implemented by the controller 21. When the updater 202 receives content from the receiver 201, the updater 202 updates order information on the classification of the content based on the order specified for the content. Every time the receiver 201 receives content, the updater 202 updates the order information on the classification of the content.

For example, the updater 202 updates the order information so that the order of received content matches the order specified by the poster. For example, the updater 202 does not change the order of content having a higher place in order than that of the received content, and changes the order of content having a lower place in order than that of the received content so that the order is decreased by one.

### [3-4. Determiner]

The determiner 203 is mainly implemented by the controller 21. The determiner 203 determines a plurality of classifications to be displayed on the page P6 of the poster based on classification information assigned to each piece of content. In at least one embodiment, the classification is displayed by the classification tab T612, and thus the determiner 203 determines the classification for which the classification tab T612 is to be displayed.

The determiner 203 may determine all the classifications specified by the poster as the classifications to be displayed on the page P6, or determine a part of the classifications specified by the poster as the classifications to be displayed on the page P6. When only a part of the classifications is displayed on the page P6, the determiner 203 may determine a predetermined number of classifications in order of a larger number of pieces of content as the classifications to be displayed on the page P6. Further, for example, the determiner 203 may determine a classification for which the number of pieces of content is equal to or larger than a threshold value as the classification to be displayed on the page P6. Further, for example, the determiner 203 may determine a part of classifications, which are randomly selected, as the classifications to be displayed on the page P6.

The order of classifications on the page P6 may be an order registered in the server 20, or may be specified by the poster. The order of classifications is the order of display on the page P6. For example, when classifications are arranged in a horizontal direction, the order is a numerical value indicating at which place in order each classification is displayed from the left or the right. Further, for example, when classifications are arranged in a vertical direction, the order is a numerical value indicating at which place in order each classification is displayed from the top.

For example, the determiner 203 may determine the order of each classification based on the number of pieces of content of the classification to be displayed on the page P6. The determiner 203 determines the order of each classification so that the classification is displayed in order of a larger number of pieces of content. In other words, the determiner 203 determines the order of each classification so that the classification is displayed in descending order of the number of pieces of content.

### [3-5. Page Generator]

The page generator 204 is mainly implemented by the controller 21. The page generator 204 generates the page P6 on which each classification determined by the determiner 203 can be selected, and on which, when some classification is selected, content of the classification is displayed. The page P6 may have any data format, and may have, for example, an html format, an xml format, or a document file format.

The phrase “each classification can be selected” means that a selective image for selecting a classification is displayed on the page P6. The selective image is an image for selecting a classification. In at least one embodiment, the classification tab T612 is described as an example of the selective image. Thus, the description of the “classification tab T612” in at least one embodiment can be replaced with the “selective image”. The page generator 204 enables selection of the classification tab T612 for each classification determined by the determiner 203, and when some classification tab T612 is selected, generates the page P6 on which content of the classification indicated by the classification tab T612 is displayed. The selective image maybe an image having any format, and may be, for example, a button, a checkbox, text in which a hyperlink is embedded, or a pull-down menu. Alternatively, for example, the selective image may be an image called “(main) menu” or “global navigation”.

For example, the page generator 204 arranges, on the page P6, the classification tab T612 for selecting a classification for each classification determined by the determiner 203. In at least one embodiment, the determiner 203 determines the order based on the number of pieces of content of each classification, and thus the page generator 204 generates the page P6 on which the classifications are arranged in the order determined by the determiner 203.

Data indicating the layout of the page P6 is only required to be stored in the data memory 200 in advance, and the display position of the classification tab T612 is only required to be defined in this data. For example, the page generator 204 arranges, on the page P6, the classification tab T612 for indicating each classification determined by the determiner 203 based on the layout of the page P6.

Further, for example, when some classification is selected, the page generator 204 may generate a page on which pieces of content of the classification are arranged based on order information within the classification. For example, when some classification is selected, the page generator 204 refers to the content database DB2 to acquire order information within the classification. Then, the page generator 204 generates the page P6 on which pieces of content of the selected classification are arranged based on the order information within the classification.

In at least one embodiment, each piece of content includes an image, and the page P6 displays, for each classification determined by the determiner 203, the classification tab T612 for selecting the classification. Thus, the page generator 204 may generate the page P6 on which the classification tab T612 for the classification determined by the determiner 203 includes an image of first content in the classification. The page generator 204 refers to the content database DB2 to identify first content in the classification based on the order information within the classification. The page generator 204 embeds the image of the content into the classification tab T612 to generate the classification tab T612.

Further, in at least one embodiment, each piece of content not only includes an image or moving image, but includes a description and assigned information. Those plurality of items are grouped, and thus the poster terminal 10 may allow specification of the order for each piece of grouped content. The page generator 204 generates the page P6 on which those pieces of grouped content are arranged in the order specified by the poster.

### 4. PROCESSING TO BE EXECUTED IN AT LEAST ONE EMBODIMENT

Next, a description is given of processing to be executed in the page generation system S. Now, a description is given of a case in which content posting processing for posting content and page generation processing for generating a page are executed. The processing described below is an example of processing to be executed by the functional blocks illustrated in FIG. 11.

### [4-1. Content Posting Processing]

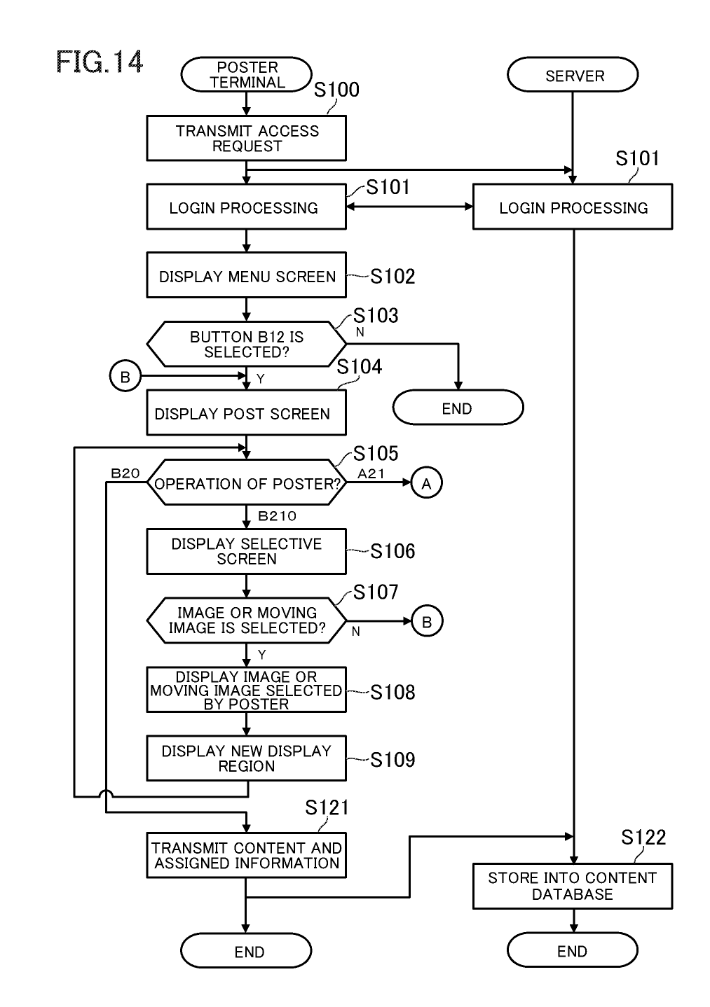

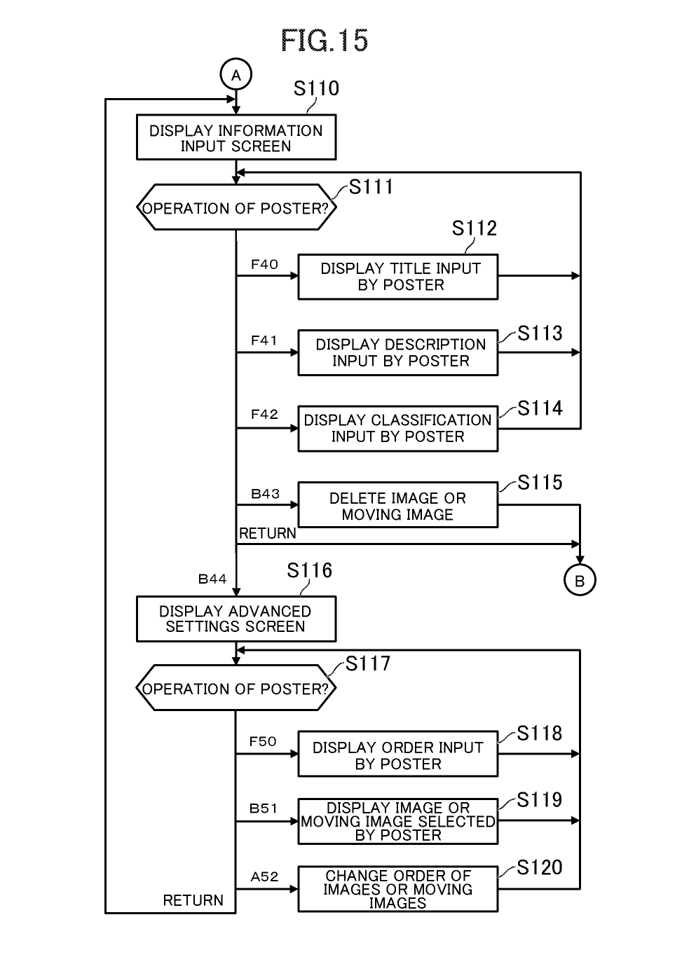

FIG. 14 and FIG. 15 are flowcharts for illustrating the content posting processing. The content posting processing illustrated in FIG. 14 and FIG. 15 is executed by the controllers 11 and 21 operating in accordance with respective programs stored in the memories 12 and 22.

As illustrated in FIG. 14, first, the controller 11 of the poster terminal 10 transmits an access request to the server 20 (Step S100), and predetermined login processing is executed between the poster terminal 10 and the server 20 (Step S101). In Step S100, when the poster operates the operation interface 14 to specify an URL on the menu screen G1 by a browser or activate a predetermined application, the controller 11 transmits an access request to the server 20. The access request may be a request having a predetermined data format, and may include a poster ID, for example. In Step S101, the poster may input an account and a password, or an account and a password stored in the memory 12 may be transmitted to the server 20.

When the login processing is successful, the controller 11 of the poster terminal 10 displays the menu screen G1 on the display 15 (Step S102). In Step S102, the controller 21 of the server 20 transmits display data on the menu screen G1 to the poster terminal 10. When the poster terminal 10 has received the display data, the controller 11 displays the menu screen G1 on the display 15 based on the display data.

The controller 11 determines whether or not the poster has selected the button B12 based on a detection signal from the operation interface 14 (Step S103). When it is not determined that the poster has selected the button B12 (Step S103: N), this means that any one of the other buttons B10, B11, and B13 is selected. Thus, processing that depends on the selected button is executed, and the processing is finished.

On the contrary, when it is determined that the poster has selected the button B12 (Step S103: Y), the controller 11 displays the post screen G2 on the display 15 (Step S104). In Step S104, the controller 11 may request the server 20 for display data on the post screen G2, or may display the post screen G2 without particularly issuing a request for the server 20 when the post screen G2 can be displayed through processing of an application stored in the memory 12. This point holds true also for the other screens, namely, the selection screen G3, the information input screen G4, and the advanced settings screen G5.

The controller 11 identifies the operation of the poster based on a detection signal from the operation interface 14 (Step S105). It is assumed that, in Step S105, an operation of selecting the button B20, an operation of selecting the button B210, or an operation of selecting the display region A21 is performed. In this case, it is assumed that the button B20 cannot be selected under a state in which an image or moving image is not selected yet. Further, it is assumed that the display region A21 on which an image or moving image is not displayed cannot be selected.

When the poster has selected the button B210 (Step S105: B210), the controller 11 displays the selection screen G3 on the display 15 based on image data and moving image data stored in the memory 12 (Step S106). In Step S106, the controller 11 displays, on the display 15, the selection screen G3 on which at least one of a plurality of images or a plurality of moving images can be selected based on a plurality of pieces of image data and a plurality of pieces of moving image data stored in the memory 12.

The controller 11 determines whether or not an image or moving image displayed on the selection screen G3 is selected based on a detection signal from the operation interface 14 (Step S107). When it is not determined that an image or moving image is selected (Step S107: N), the processing returns to the processing of Step S104, and the post screen G2 is displayed again.

On the contrary, when it is determined that an image or moving image is selected (Step S107: Y), the controller 11 deletes the selection screen G3, displays the image or moving image selected by the poster on the display region A21 of the post screen G2 (Step S108), and displays the new display region A21 (Step S109). As illustrated in FIG. 4, in Step S108, the selected image or moving image is displayed on the display region A21A, and in Step S109, the new display region A21B is displayed so that an image or moving image can be added.

On the contrary, when it is determined in Step S105 that the poster has selected the display region A21 (Step S105: A21), the processing proceeds to FIG. 15, and the controller 11 displays the information input screen G4 on the display 15 (Step S110). In Step S110, the controller 11 displays, on the information input screen G4, the image or moving image indicated by the selected display region A21.

The controller 11 identifies an operation of the poster based on a detection signal from the operation interface 14 (Step S111). It is assumed that, in Step S111, an operation of inputting a title into the input form F40, an operation of inputting a description into the input form F41, an operation of inputting a classification into the input form F42, an operation of selecting the button B43, an operation of selecting the button B44, or an operation of returning to the post screen G2 is performed.

When the poster has input a title into the input form F40 (Step S111: F40), the controller 11 displays the title input by the poster on the input form F40 (Step S112), and the processing returns to the processing of Step S111. The title input by the poster is temporarily stored in the memory 12.

When the poster has input a description into the input form F41 in Step S111 (Step S111: F41), the controller 11 displays the description input by the poster on the input form F41 (Step S113), and the processing returns to the processing of Step S111. The description input by the poster is temporarily stored in the memory 12.

When the poster has input a classification into the input form F42 in Step S111 (Step S111: F42), the controller 11 displays the classification input by the poster on the input form F42 (Step S114), and the processing returns to the processing of Step S111. The classification input by the poster is temporarily stored in the memory 12.

When the poster has selected the button B43 in Step S111 (Step S111: B43), the controller 11 deletes the image or moving image selected by the poster (Step S115), and the processing returns to the processing of Step S104, and the post screen G2 is displayed. In this case, the display region A21 indicating the image or moving image selected by the poster is deleted from the post screen G2.

When the poster has selected the button B44 in Step S111 (Step S111: B44), the controller 11 displays the advanced settings screen G5 on the display 15 (Step S116). In Step S116, the controller 11 displays the selected image or moving image on the display region A52 of the advanced settings screen G5.

The controller 11 identifies an operation of the poster based on a detection signal from the operation interface 14 (Step S117). It is assumed that, in Step S117, any one of an operation on the input form F50, an operation of selecting the button B51, an operation on the display region A52, and an operation of returning to the information input screen G4 is performed.

When an operation on the input form F50 is performed (Step S117: F50), the controller 11 displays the order of each classification specified by the poster on the input form F50 (Step 5118), and the processing returns to the processing of Step S117. The order of each classification specified by the poster is temporarily stored in the memory 12.

When the poster has selected the button B51 in Step S117 (Step S117: B51), the controller 11 displays the image or moving image selected by the poster on the display region A52 (Step S119), and the processing returns to the processing of Step S117. In Step S119, similarly to the processing of Step S106 and Step S107, the controller 11 may display the selection screen G3 on the display 15, and receive selection of an image or moving image by the poster.

When an operation on the display region A52 is performed in Step S117 (Step S117: A52), the controller 11 changes the order of images or moving images in the content based on the order specified by the poster (Step S120), and the processing returns to the processing of Step S120. The order in the content specified by the poster is temporarily stored in the memory 12.

When an operation of returning to the information input screen G4 is performed in Step S117 (Step S117: return), the processing returns to the processing of Step S110, and the information input screen G4 is displayed on the display 15. Further, when an operation of returning to the post screen G2 is performed in Step S111 (Step 5111: return), the processing returns to the processing of Step 5104 of FIG. 14, and the post screen G2 is displayed on the display 15.

When it is determined in Step S105 that the poster has selected the button B20 (Step S105: B20), the controller 11 transmits to the server 20 the content selected by the poster and the assigned information input by the poster (Step S121). In Step S121, the controller 11 transmits the assigned information including, for example, the title input in Step S112, together with image data or moving image data stored in the storage 12.

When the controller 21 of the server 20 has received the content and the assigned information, the controller 21 stores the content and the assigned information into the content database DB2 (Step S122), and the processing is finished. In Step S122, the controller 21 creates a new record in the content database DB2, and issues a content ID of the received content. Then, the controller 21 stores the received content and assigned information in association with the content ID. Further, in Step S122, the controller 21 updates the poster database DB1 based on the classification information on the received content. For example, when the poster has specified a new classification, the controller 21 stores the new classification into the poster database DB1. Further, for example, when the poster has posted content of the specified classification, the controller 21 increases the number of pieces of content of that classification in the poster database DB1.

### [4-2. Page Generation Processing]

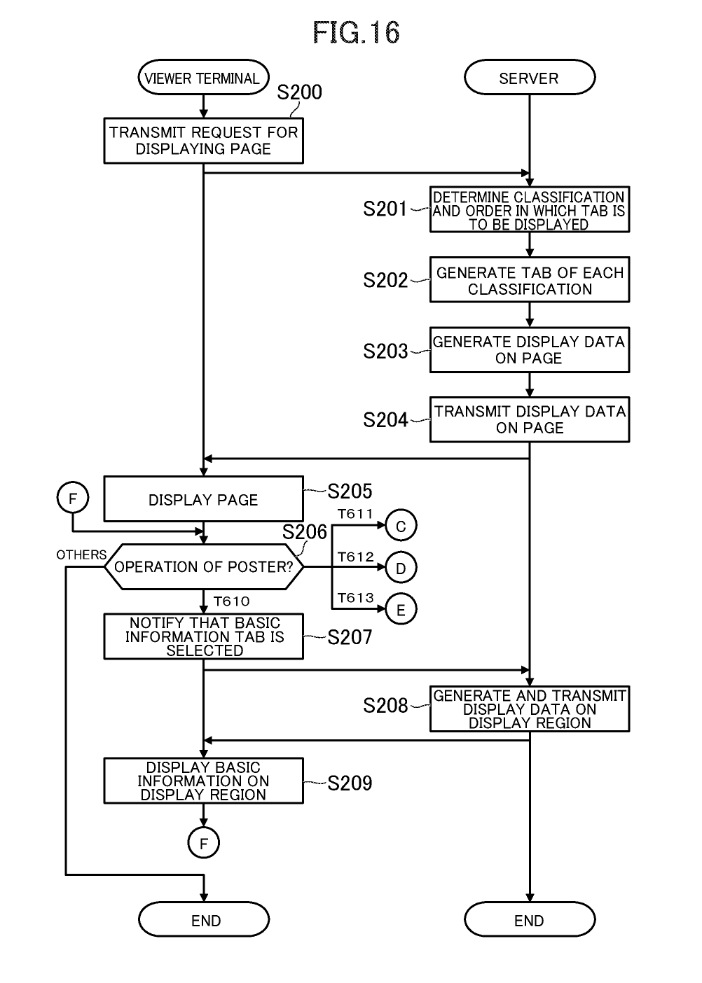

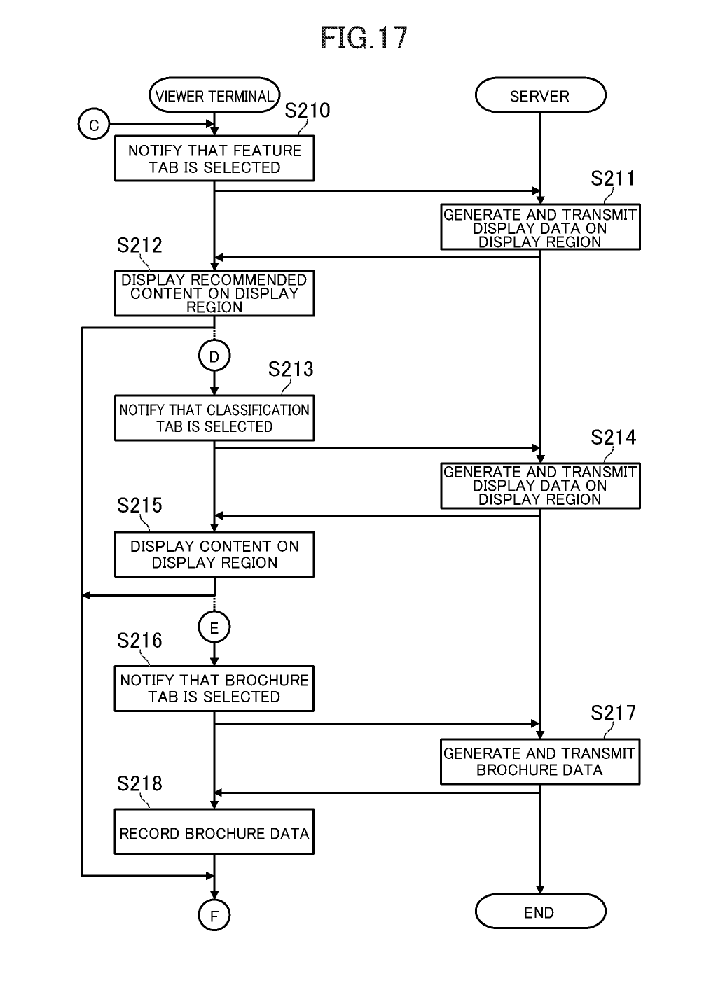

FIG. 16 and FIG. 17 are flowcharts for illustrating the page generation processing. The page generation processing illustrated in FIG. 16 and FIG. 17 is executed by the controllers 21 and 31 operating in accordance with respective programs stored in the memories 22 and 32.

As illustrated in FIG. 16, the controller 31 of the viewer terminal 30 transmits to the server 20 a request for displaying the page P6 (Step S200). In Step S200, when the viewer operates the operation interface 34 to specify an URL on the page P6 by a browser or specify a poster via a predetermined application, the controller 11 transmits a request for displaying the page P6.

When the server 20 has received a display request, the controller 21 determines, based on the poster database DB1, the classification and order in which the classification tab T612 is to be displayed on the page P6 (Step S201). In Step S201, the controller 21 refers to a record corresponding to the poster of the page P6 from among the records of the poster database DB1, identifies a predetermined number of classifications in descending order of the number of pieces of content stored in the record, and determines the order of each classification so that the classifications are arranged in descending order of the number of pieces of content.

The controller 21 generates the classification tab T612 for each classification determined in Step S201 based on the content database DB2 (Step S202). In Step S202, the controller 21 generates, for each classification determined in Step S201, the classification tab T612 including the classification name and the image of first content.

The controller 21 generates display data on the page P6 on which the classification tabs T612 generated in Step S202 are arranged in the order determined in Step S201 (Step S203). In Step S203, the controller 21 arranges the classification tabs T612 generated in Step S202 in descending order of the number of pieces of content. It is assumed that the display data includes information enabling identification of the classification indicated by the classification tab T612. The controller 21 transmits the display data on the page P6 generated in Step S203 to the viewer terminal 30 (Step S204).

When the viewer terminal 30 has received the display data, the controller 31 displays the page P6 (Step S205). Now, a description is given of processing in a case where a menu of “information” is selected on the display region A60. However, when another menu is selected, content that depends on the menu is displayed on the display region A62.

The controller 11 identifies an operation of the viewer based on a detection signal from the operation interface 14 (Step S206). It is assumed that, in Step S206, any one of an operation of selecting the basic information tab T610, an operation of selecting the feature tab T611, an operation of selecting the classification tab T612, an operation of selecting the brochure tab T613, an operation of closing the page P6, and other operations is performed.

When the viewer has selected the basic information tab T610 (Step S206: T610), the controller 11 notifies the server 20 of the fact that the basic information tab T610 is selected (Step S207). When the server 20 has received the notification, the controller 21 generates and transmits display data on the display region A62 corresponding to the basic information tab T610 (Step S208). In Step S208, the controller 21 generates the display data on the display region A62 based on the basic information stored in the poster database DB1. When the viewer terminal 30 has received the display data, the controller 31 displays the basic information on the poster on the display region A62 (Step S209).

When the viewer has selected the feature tab T611 in Step S206 (Step S206: T611), the processing proceeds to FIG. 17, and the controller 21 notifies the server 20 of the fact that the feature tab T611 is selected (Step S210). When the server 20 has received the notification, the controller 21 generates and transmits display data on the display region A62 corresponding to the feature tab T611 (Step S211). In Step S211, the controller 21 generates the display data on the display region A62 based on any piece of content among pieces of content stored in the content database DB2. When the viewer terminal 30 has received the display data, the controller 31 displays a recommended piece of content on the display region A62 (Step S212).

When the viewer has selected the classification tab T612 in Step S206 (Step S206: T612), the processing proceeds to FIG. 17 to notify the server 20 of the fact that the classification tab T612 is selected (Step S213).

When the server 20 has received the notification, the controller 21 generates and transmits display data on the display region A62 corresponding to the classification tab T612 (Step S214). In Step S214, the controller 21 refers to a record of the classification indicated by the classification tab T612 from among the records of the content database DB2. The controller 21 arranges pieces of content stored in the record on the display region A62 based on order information within the classification stored in the record and order information within the content. Regarding content to which a title is assigned, the controller 21 arranges the title at the top of the content.

When the viewer terminal 30 has received the display data, the controller 31 displays content of the classification indicated by the classification tab T612 on the display region A62 (Step S215). In Step S215, as described with reference to FIG. 10, pieces of content indicated by the classification tab T612 selected by the viewer are displayed in the order specified by the poster.

When the viewer has selected the brochure tab T613 in Step S206 (Step S206: T613), the processing proceeds to FIG. 17, and the controller 31 notifies the server 20 of the fact that the brochure tab T613 is selected (Step S216). When the server 20 has received the notification, the controller 21 generates and transmits brochure data based on content being displayed on the page (Step S217). When the viewer terminal 30 has received the brochure data, the controller 31 stores the brochure data in the memory (Step S218).

When the viewer has performed other operations in Step S206 (Step S206: others), processing of closing the page P6 is executed, and the processing is finished.

With the page generation system S according to at least one embodiment, the classification to be displayed on the page P6 of the poster is determined based on classifications assigned to content, and new content can be easily added to the page P6 on which pieces of content are displayed in a classified manner. Further, even when a classification that fits new content is not specified yet, the page generation system S determines a classification of the new content. Thus, also in this case, it is possible to easily add a new classification. Further, the poster can specify any classification, and thus a classification that depends on details of content can be selected, and a user-friendly user interface can be provided. Further, a plurality of classifications can be specified for content, and the content can be called when any one of those plurality of classifications is selected. In this respect, when separate pages are prepared for the respective classifications, data on content is required to be prepared for each page. However, in the page generation system S, content is only required to be called from one piece of data, and thus it is possible to suppress the amount of memory consumption by the server 20.

Further, in the poster terminal 10, the order of content within the classification is specified, and when a classification is selected on the page P6, the page P6 on which pieces of content are arranged is generated based on the order information within the classification, to thereby be able to generate the page P6 on which pieces of content are arranged in the order intended by the poster.

Further, it is possible to provide a user interface through which content of a classification is easily grasped in a visual manner by displaying the first content in the classification as a representative image. That is, content specified by the poster as the first content represents the characteristic of the classification best, and thus it is possible to provide a user interface through which the characteristic of the classification is easily grasped by displaying that content as the representative image on the classification tab T612.

Further, a plurality of items of each piece of content, such as an image or a description, are grouped, and the order can be specified for each piece of grouped content, to thereby be able to generate the page P6 on which pieces of grouped content are arranged in the order intended by the poster.

Further, it is possible to provide a more user-friendly user interface by determining the order of each classification to be displayed on the page P6 based on the number of pieces of content of that classification, and arranging classifications in descending order of the number of pieces of content.

Further, it is possible to provide a more user-friendly user interface by arranging the classification tab T612 on the page P6 as a selective image.

### 5. MODIFICATION EXAMPLES

The present invention is not limited to at least one embodiment described above, and can be modified suitably without departing from the spirit of the present invention.

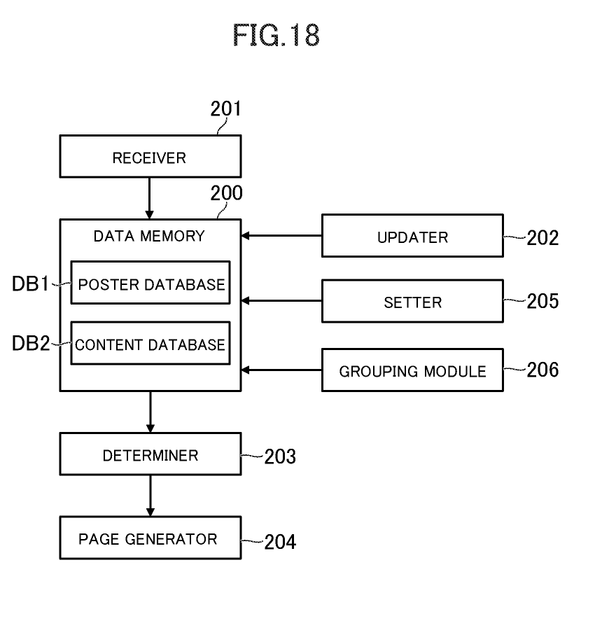

FIG. 18 is a functional block diagram in modification examples of the present invention. As illustrated in FIG. 18, in the modification examples described below, a setter 205 and a grouping module 206 are implemented in addition to the functions described with reference to at least one embodiment.

(1) For example, in the poster terminal 10, an effective period of each piece of content may be specified. The effective period is a period in which content is to be displayed, or a period in which a classification assigned to content is to be displayed as the classification tab T612. In other words, the effective period is a period in which a classification assigned to content can be selected. For example, a start time point and an end time point may be set for the effective period, or only the end time point may be set for the effective period.

In a case where both the start time point and the end time point are set for the effective period, when a time point of posting of content is before the start time point, the content does not become effective until the time point of posting of the content reaches the start time point. That is, the posted content is not displayed on the page P6 or the classification of that content is not displayed as the classification tab T612 until the start time point arrives. After that, when the start time point has arrived, the content becomes effective. That is, when the start time point has arrived, the posted content is displayed on the page P6, or the classification of that content is displayed as the classification tab T612. Then, when the end time point has arrived, the posted content is no longer displayed on the page P6, or the classification of that content is no longer displayed as the classification tab T612.

When only the end time point is set for the effective period, content is effective after the content is posted until the end time point arrives. That is, content becomes effective as soon as the content is posted, and the posted content is displayed on the page P6, or the classification of that content is displayed as the classification tab T612 until the end time point arrives. After that, when the end time point has arrived, the content becomes ineffective. That is, when the end time point has arrived, the posted content is no longer displayed on the page P6, or the classification of that content is no longer displayed as the classification tab T612.

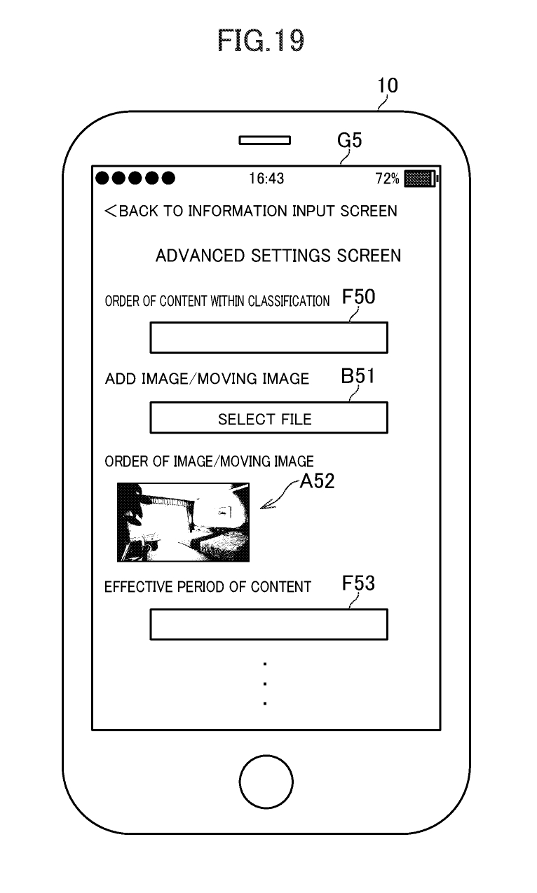

FIG. 19 is a diagram for illustrating an example of the advanced settings screen G5 in Modification Example (1) of the present invention. As illustrated in FIG. 19, the advanced settings screen G5 in Modification Example (1) displays an input form F53 for inputting an effective period of content. As illustrated in FIG. 19, for example, the poster selects the input form F53 on the advanced settings screen G5, and inputs any number indicating an effective period of the selected image or moving image. The method of inputting an effective period is not limited to inputting of a number. For example, an effective period maybe input in a pull-down format, or a calendar may be displayed to input an effective period.

The page generation system S according to Modification Example (1) includes the setter 205. The setter 205 is mainly implemented by the controller 21. The setter 205 sets an effective period in content for which the effective period is specified. For example, the content database DB2 in Modification Example (1) stores an effective period of each piece of content. The setter 205 stores the effective period specified by the poster into the content database DB2 in association with the content, to thereby set the effective period in the content.

For example, the determiner 203 does not determine the classification of content for which the effective period has elapsed as the classification to be displayed on the page P6, and determines the classification of content for which the effective period has not elapsed as the classification to be displayed on the page P6. The determiner 203 acquires the current date and time by using, for example, a real-time clock, to determine whether or not the current date and time falls within the effective period of each piece of content. The determiner 203 does not arrange the classification tab T612 on the page P6 for content for which the effective period has elapsed, and arranges the classification tab T612 on the page P6 for content for which the effective period has not elapsed.

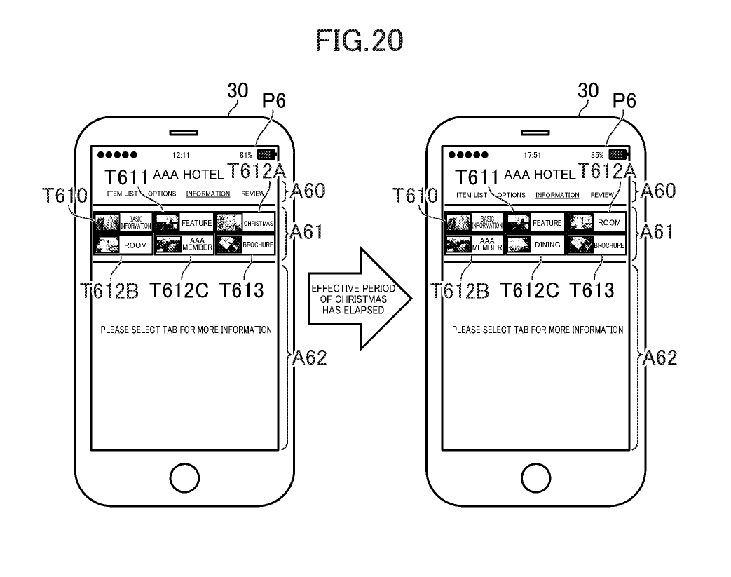

FIG. 20 is a diagram for illustrating transition of the page P6 before and after elapse of the effective period. As illustrated in FIG. 20, the page P6 displays the classification tabs T612A to T612C, and the classification tabs T612A to T612C represent the classifications of “Christmas”, “Room”, and “AAA member”, respectively. Regarding those classifications, it is assumed that “Dec. 25, 2018” is set as the effective period in the content of “Christmas”.

In this case, the determiner 203 determines whether or not the current date and time is after “Dec. 25, 2018”. When the current date and time is after “Dec. 25, 2018”, the determiner 203 does not determine the classification of “Christmas” as the classification to be displayed on the page P6. Thus, as illustrated in FIG. 20, when the effective period of “Christmas” has elapsed, the classification tab T612A of “Christmas” is no longer displayed, and instead, the respective classification tabs T612 of “Room”, “AAA member”, and “dining” are displayed.

According to Modification Example (1), the effective period is set in content, and the classification tab T612 is not displayed for the classification of content for which the effective period has elapsed, and the classification tab T612 is displayed for the classification of content for which the effective period has not elapsed. It is thus possible to prevent unrequired information from being displayed continuously. Further, it is possible to save the time and effort of the poster to manually delete the classification tab T612.

(2) Further, for example, in the poster terminal 10, the title of content can be omitted, and when content for which the title is specified and content for which the title is omitted are posted successively, those pieces of content may be grouped and regarded as one piece of content. When a specification in which only one image or moving image is allowed to be posted in one post is adopted, individual images or moving images are treated as separate pieces of content in many cases. With Modification Example (2) of the present invention, a plurality of images or moving images can grouped as one piece of content even under such a specification, which is particularly beneficial.

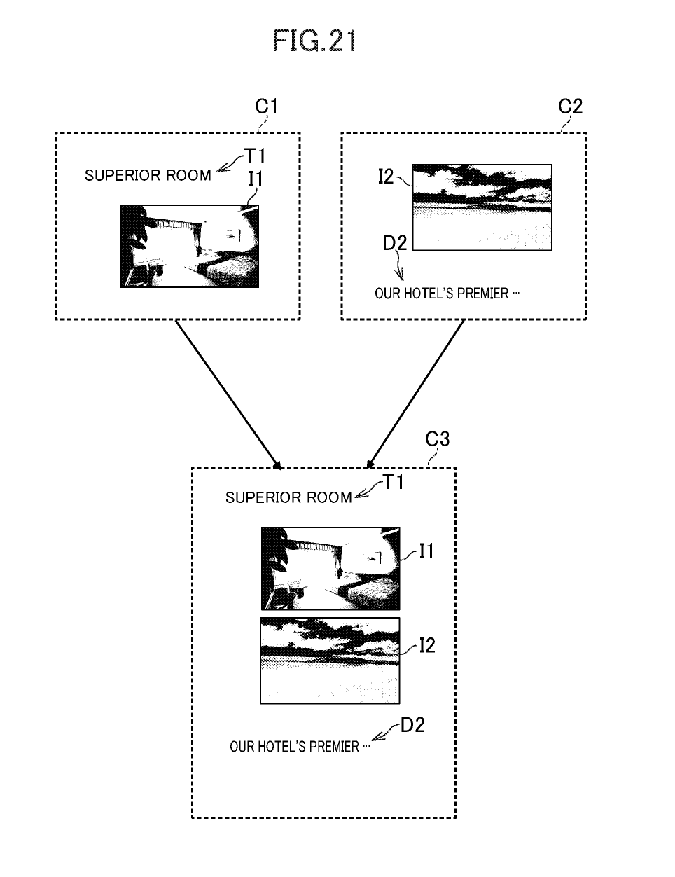

FIG. 21 is an explanatory diagram for illustrating processing in Modification Example (2). In the example of FIG. 21, content C1 includes an image I1, a title T1 of “superior room” is input, and a description is omitted. Meanwhile, content C2 includes an image I2, a description D2 is input, and a title is omitted. When those two pieces of content C1 and C2 are posted at the same time, as illustrated in FIG. 21, those two pieces of content C1 and C2 may be regarded as one piece of content C3, and the title T1, the image I1, the image I2, and the description D2 may be arranged in the content C3 in the stated order.

The page generation system S according to Modification Example (2) includes the grouping module 206. The grouping module 206 is mainly implemented by the controller 21. When the receiver 201 has received first content for which the title is specified and second content for which the title is not specified, the grouping module 206 groups the first content and the second content.

The first content is content for which the title is specified, and may include a description. Herein, it is assumed that the first content includes a specified first image, and the description (character string) of the first content is omitted. Further, for example, the second content is content for which the title is not specified, and a description may be omitted. Herein, it is assumed that the second content includes a specified second image and a specified description (character string).

For example, the order of images and descriptions within the grouped first content and second content may be determined by any method. For example, the images and descriptions may be displayed in descending order of time points of posting, or the second image may be displayed before the first image. Herein, as illustrated in FIG. 21, it is assumed that, when the classification of the grouped first content and second content is selected, the page generator 204 generates a page on which the title of the first content, the first image, the second image, and the character string are displayed in the stated order for the grouped first content and second content.

With Modification Example (2), the first content for which the title is specified and the second content for which the title is not specified are grouped, to thereby be able to generate the page P6 enabling content to be easily viewed. Further, for example, even when a specification in which only one image or moving image is allowed to be posted in one post is adopted, a plurality of pieces of content can be grouped as one piece of content to facilitate management of content, which is particularly beneficial.

Further, when the first image is specified, and the first content for which the character string is omitted and the second content for which the second image and the character string are specified are posted, the title, the first image, the second image, and the character string are displayed in the stated order, to thereby be able to display the page P6 under such a state in which the grouped content is easily viewed.

(3) Further, for example, the above-mentioned modification examples may be combined.

Further, for example, in at least one embodiment, a description has been given of a case in which the order of an image or moving image is specified after selection of the image or moving image by the poster. However, the order of an image or moving image may be specified before selection of the image or moving image. That is, the order of an image or moving image to be selected may be specified first, and then the image or moving image maybe selected. For example, the post screen G2 may display pieces of posted content, and the poster may specify the order of those pieces of posted content, and then select an image or moving image to be inserted into this order.

Further, for example, the classification of posted content may be specified on the post screen G2, and when the poster specifies a classification, the posted image or moving image may be displayed (that is, the current page P6 may be displayed). After that, when the poster specifies the order (e.g., between first image and second image) of insertion of an image or moving image (image or moving image that is not selected yet), the button B210 maybe displayed, and then the image or moving image may be selected and posted. In this case, the selected image or moving image is inserted into the specified order (e.g., second). In this case, the order of posted content after the specified order is decreased by one.

Further, for example, in at least one embodiment, an exemplary description has been given of the page P6 introducing a facility. However, the page generation system S may generate various types of pages. For example, the page generation system S may generate a page introducing a company, a blog page of the poster, or a page of the poster relating to a social networking service. Also in this case, similarly to at least one embodiment, the page generation system S is only required to generate a page enabling selection of a classification specified by the poster.

Further, for example, in at least one embodiment, a description has been given of a case in which the classification tab T612 to be displayed on the page P6 is determined based on classification information assigned to content. However, the poster may manually set the classification tab T612. In this case, the determiner 203 may be omitted. Further, when the determiner 203 is omitted from the page generation system S, the page generation system may only include the receiver 201, the updater 202, and the page generator 204.

Further, for example, the poster terminal 10, the server 20, and the viewer terminal 30 may implement the functions in a distributed manner. Further, for example, the determiner 203 may be implemented by the viewer terminal 30. In this case, the determiner 203 is mainly implemented by the controller 31. The determiner 203 of the viewer terminal 30 may acquire classification information on content posted by the poster from the server 20, and determine the classification to be displayed on the page P6 based on the classification information. Further, for example, the page generator 204 may be implemented by the viewer terminal 30. In this case, the page generator 204 is mainly implemented by the controller 31. The page generator 204 of the viewer terminal 30 may acquire the classification determined by the determiner 203 of the server 20, or acquire the classification determined by the determiner 203 of the viewer terminal 30. The page generator 204 of the viewer terminal 30 generates the page P6 based on the acquired classification.

Further, for example, data described as being stored into the data memory 200 may be stored in a database server different from the server 20, or may be stored in a database server outside the page generation system S.

What is claimed is:

1. A page generation system, comprising at least one processor,
wherein the at least one processor is configured to receive, from a poster terminal, each of a plurality of pieces of content to which classification information on a classification is assigned,
wherein the at least one processor is configured to determine a plurality of classifications to be displayed on a page of a poster based on the classification information assigned to each of the plurality of pieces of content, and
wherein the at least one processor is configured to generate the page on which each of the determined plurality of classifications is allowed to be selected, and on which, when any one of the determined plurality of classifications is selected, content of the selected one of the determined plurality of classifications is displayed.

2. The page generation system according to claim 1,
wherein the poster terminal is configured to enable specification of an order of each of the plurality of pieces of content,
wherein the page generation system further comprises a storage configured to store, for each of the plurality of classifications, order information on the order of each of the plurality of pieces of content of the each of the plurality of classifications,
wherein the at least one processor is configured to:
update, when one of the plurality of pieces of content is received, order information on a classification of the one of the plurality of pieces of content stored in the storage based on an order specified for the one of the plurality of pieces of content; and
generate, when one of the plurality of classifications is selected, the page on which pieces of content of the one of the plurality of classifications are arranged based on order information on the one of the plurality of classifications stored in the storage.

3. The page generation system according to claim 2,
wherein each of the plurality of pieces of content includes an image,
wherein the page displays a selective image for selecting a classification for each of the determined plurality of classifications, and
wherein the at least one processor is configured to generate the page on which the selective image for each of the determined plurality of classifications includes an image of first content within the each of the determined plurality of classifications.

4. The page generation system according to claim 2,
wherein a plurality of items of each of the plurality of pieces of content are grouped, and
wherein the poster terminal is configured to enable specification of an order for each piece of grouped content.

5. The page generation system according to claim 1, wherein the at least one processor is configured to:
determine, based on a number of pieces of content of each of the plurality of classifications to be displayed on the page, an order of the each of the plurality of classifications; and
generate the page on which the plurality of classifications are arranged in a selectable manner in the determined order.

6. The page generation system according to claim 1,
wherein the poster terminal is configured to enable specification of an effective period of each of the plurality of pieces of content, and
wherein the at least one processor is configured to:
set the specified effective period in content for which the effective period is specified;
avoid determining a classification of content for which the effective period has elapsed as a classification to be displayed on the page; and
determine a classification of content for which the effective period has yet to elapse as a classification to be displayed on the page.

7. The page generation system according to claim 1,
wherein the poster terminal is configured to enable specification of a title of each of the plurality of pieces of content, and
wherein the at least one processor is configured to, when receiving first content for which the title is specified and second content for which the title is not specified, group the first content and the second content.

8. The page generation system according to claim 7,
wherein the poster terminal is configured to enable specification of an image and a character string to be included in each of the plurality of pieces of content,
wherein the first content includes content for which a first image is specified and the character string is omitted,
wherein the second content includes content for which a second image and the character string are specified, and
wherein the at least one processor is configured to, when a classification of the grouped first content and second content is selected, generate the page on which the title of the first content, the first image, the second image, and the character string are displayed in the stated order, for the grouped first content and second content.

9. The page generation system according to claim 1, wherein the at least one processor is configured to:
enable selection of a tab of each of the determined plurality of classifications; and
generate, when any one of the tabs is selected, the page on which content of a classification indicated by the one of the tabs is displayed.

10. A page generation method, comprising:
receiving, from a poster terminal, each of a plurality of pieces of content to which classification information on a classification is assigned;
determining a plurality of classifications to be displayed on a page of a poster based on the classification information assigned to each of the plurality of pieces of content; and
generating the page on which each of the determined plurality of classifications is allowed to be selected, and on which, when anyone of the determined plurality of classifications is selected, content of the selected one of the determined plurality of classifications is displayed.

11. Anon-transitory information storage medium having stored thereon a program for causing a computer to:
receive, from a poster terminal, each of a plurality of pieces of content to which classification information on a classification is assigned;
determine a plurality of classifications to be displayed on a page of a poster based on the classification information assigned to each of the plurality of pieces of content; and
generate the page on which each of the determined plurality of classifications is allowed to be selected, and on which, when anyone of the determined plurality of classifications is selected, content of the selected one of the determined plurality of classifications is displayed.
